(19) United States
(12) Patent Application Publication
(10) Pub. No.: US 2011/0131082 A1
(43) Pub. Date: Jun. 2, 2011

(54) SYSTEM AND METHOD FOR TRACKING EMPLOYEE PERFORMANCE

(76) Inventors: Michael Manser, Fulshear, TX (US); Larry Burgess, Spring, TX (US)

(21) Appl. No.: 13/055,423

(22) PCT Filed: Jul. 21, 2009
(86) PCT No.: PCT/US09/51252

§ 371 Date: Jan. 21, 2011

Related U.S. Application Data
(60) Provisional application No. 61/082,362, filed on Jul. 21, 2008.

(51) Int. Cl. G06Q 10/00

(52) U.S. Cl. 705/7.42

(57) ABSTRACT

A computer system including a single, fully-integrated software program that allows an employer to assess employee performance for various jobs. The system includes a user interface having graphical inputs that allow a user to rate the quantitative and qualitative skills specific to a job. The system also allows the weighting of the quantitative and qualitative criteria based on job type and graphing such data against the market rate of such employee to determine the value of the employee to the organization. The system is available over a network and allows a user to compare the performance of one or multiple employees over a single period of time or over a longer period of time to track trends in employee performance.

The present application claims priority to U.S. Provisional Patent Application Ser. No. 61/082,362 filed on Jul. 21, 2008, which is herein incorporated by reference.

### BACKGROUND

The present disclosure relates to evaluation systems, and in particular, to performance and competency monitoring. More particularly, the present disclosure relates to a system, computer readable medium, and method allowing a user to evaluate and track an employee's performance and competency.

### SUMMARY

The present disclosure is directed to a system, computer readable medium, and method allowing a user to evaluate and monitor the performance and competency of one or more employees. There are several factors involved in assessing the value of a particular employee's performance and contribution to his employer in terms of relative cost. Many industry standards only ask for the traditional feedback on an employee's obvious and observable behavior, i.e. attendance, skills, and whether or not the company would hire them again. Although these are useful, they do not create a comprehensive picture of a supervisor's perceived value of an individual to the organization.

To create the true value scenario of one or more employees, a supervisor must assess the balance of “hard skills” (Production Value) and “soft skills” (Intangible Value) that are essential components of the job that the employee performs. The supervisor then evaluates the employee's performance in each of these two categories. Finally, the supervisor compares the average cost for the job in the marketplace to the cost of the employee being evaluated. In the typical employment context, by this exercise the supervisor compares the wages or salary paid to the employee to the average wages or salary paid for that job in the marketplace. Similarly, in the context of a consultant or temporary employee, the cost of the consultant or the temporary employee is compared to the average cost in the marketplace for similar services or work. The combination of performance and cost determines whether the company is receiving true value for its investment in the employee.

Another aspect of the present disclosure is a method for allowing a user to monitor the performance and competency of one or more employees, the method including the steps of: inputting one of a predetermined range of values to rate the performance of an employee in relation to the production value associated with the employee's job at the business, and inputting one of a predetermined range of values to rate the performance of the employee in relation to the intangible value associated with the employee's job at the business. The method also requires weighing the production and intangible values of the employee based upon the employee's job requirements, and calculating a weighted employee score based upon the employee's weighted production and intangible values. The method further requires comparing the weighted employee score against an average market rate of employees to determine the value of the employee and graphing the average market rate to the weighted score to graphically illustrate the value of the employee based upon job performance.

Another aspect of the present disclosure is the use of a computer readable medium having program code stored thereon for allowing a user to monitor the performance and competency of one or more employees, when executed on a computer, causing the computer to: provide a user interface to allow the user to assess the balance of hard skills and soft skills of an employee or employees, evaluate the employee's performance in each category, and compare the average cost for the job in the marketplace to the cost of the employee or employees being evaluated. The system also allows the user to compare the wages or salary paid to the employee to the average wages or salary paid for that job in the marketplace.

In the illustrative embodiments, the first application demonstrates the use of the software program to evaluate a single employee for a specific period of time. The second application extends the software program to encompass a group of employees or an entire workforce. This enables an employer to identify, motivate, reward, and retain only those employees who demonstrate superior talent value.

Additional features of the disclosure will become apparent to those skilled in the art upon consideration of the following detailed description of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is a graphical view of assessment controls for the assessment module;

FIG. 2 is an enlarged view of a portion of FIG. 1 showing the slide scale settings for weighting production and intangible values of an employee;

FIG. 3 is an enlarged view of a portion of FIG. 1 showing the adjustment dials used to input employee contribution to production and intangible values;

FIG. 4 is an enlarged view of a portion of FIG. 1 showing the weighted score for an employee in a dial format;

FIG. 5 is an enlarged view of a portion of FIG. 1 showing the rate factor of an employee against a perception of the current market rate;

FIG. 6 is a graph from FIG. 1 showing the graphing of an employee's performance against cost;

FIG. 7 is a graphical view of quantitative criteria for an employee's evaluation;

FIG. 8 is an enlarged view of a portion of FIG. 7 showing the evaluation period and the employee's name for a given employee;

FIG. 9 is an enlarged view of a portion of FIG. 7 showing a summary of the employee's current demographics

FIG. 10 is an enlarged view of a portion of FIG. 7 showing the quantitative criteria that have been defined for an employee's job title and work location;

FIG. 11 is an enlarged view of a portion of FIG. 7 showing a text box where a supervisor indicates their evaluation of the employee's performance with regard to the specified Quantitative criteria.

FIG. 12 is an enlarged view similar to FIG. 11;

FIG. 13 is a graphical view of a summary of an employee's evaluation after the appropriate qualitative and quantitative criteria have been entered;

FIG. 14 is a graphical view of a summary of the results of all evaluations across the organization of a given time period;

FIG. 15 is a is similar to FIG. 14 but broke out by category;

FIG. 16 is a graphical view of a scatter gram of all employees who were evaluated for a specified period;

FIG. 17 is a graphical view of a scatter gram of qualitative and quantitative scores for all employees who report to a given supervisor;

FIG. 18 is a graphical view similar to FIG. 17 showing that a user can hover their mouse over a given scatter plot and review independent employees on the chart;

FIG. 19 is a graphical view of the detailed evaluation for a given employee selected in FIG. 18;

FIG. 20 is a graphical view of a distribution curve of all cumulative scores for employees;

FIG. 21 is a graphical view of the cumulative scores of employees with regard to employee tenure with the organization;

FIG. 22 is a graphical view of an employee's compensation in view of their cumulative score;

FIG. 23 is a graphical view of an organizational-level overview of the evaluation results that is available to supervisors;

FIG. 24 is a graphical view of all supervisors and the percentage of evaluations that have been completed for a given period.

FIG. 25 is a flow diagram of the mechanism used for accessing, creating, and updating the evaluation for an employee or a series of employees; and

FIG. 26 is a flow diagram of the Performance Management Optimization process used by the program in evaluating an employee or a series of employees.

### DETAILED DESCRIPTION

While the present disclosure may be susceptible to embodiment in different forms, there is shown in the drawings, and herein will be described in detail, embodiments with the understanding that the present description is to be considered an exemplification of the principles of the disclosure and is not intended to limit the disclosure to the details of construction and the arrangements of components set forth in the following description or illustrated in the drawings.

The present disclosure combines employee performance evaluation with the cost of the employee to the employer to provide a unique measurement of the, cost, or value of an employee to his or her employer. This system is provided on a software medium that allows the user to enter criteria through input using visual dials 12, 14. By use of this system a company can compare the cost of an employee to the average cost of a person performing equivalent tasks in the general workforce. The program also effectively enables a company to determine the “return on investment” in each member of its workforce and of the overall workforce.

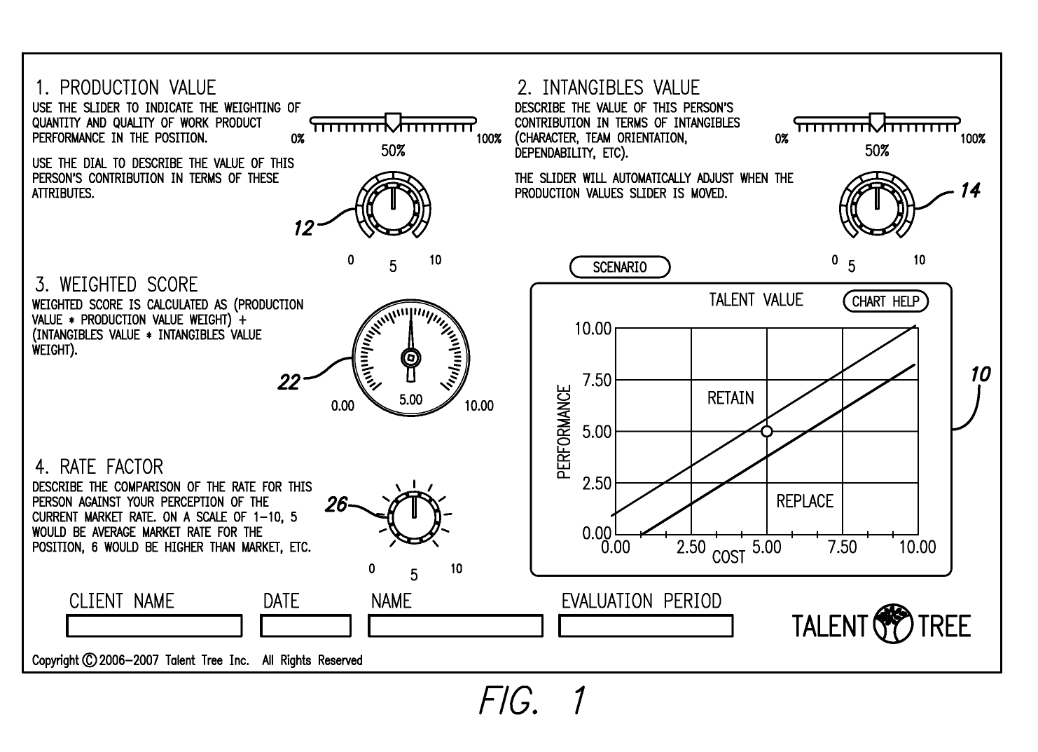

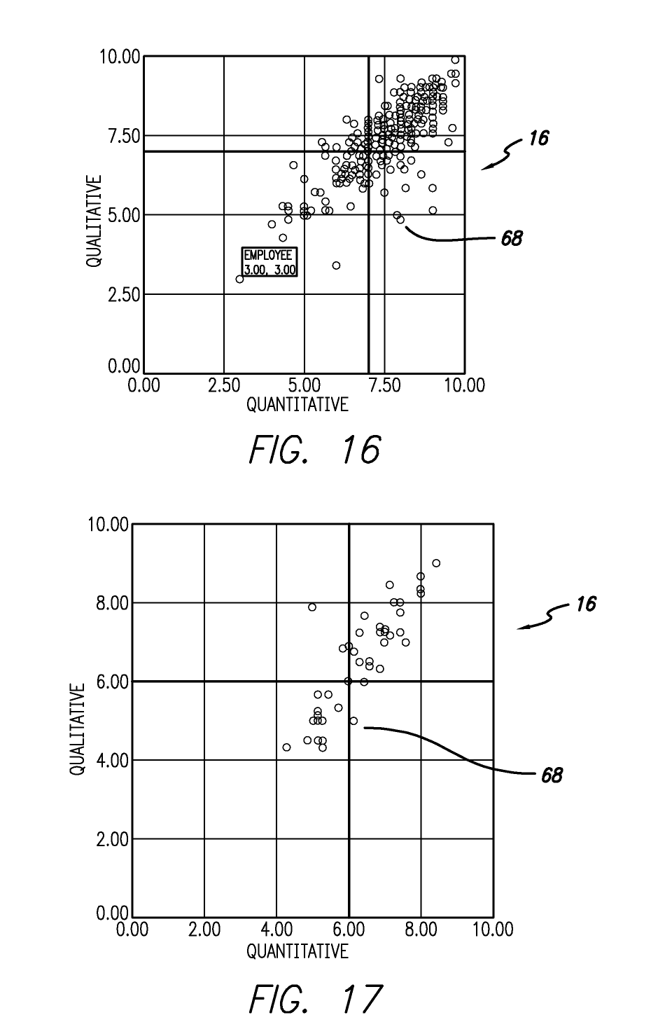

The technology by which this concept is implemented is particularly related to the evaluation of the performance and cost of his/her direct employees are displayed using a user interface in easy-to-read metrics in a graphical dashboard format with virtual dials 12, 14 to allow for the selection, as shown in FIG. 1. Second, the dashboard graphical technology allows a supervisor to compare a particular employee's cost, or value, with the value of other employees in a graphical interface 16 in the organization who are performing the same job, as shown in FIGS. 16 and 17.

Third, a supervisor is able to review an employee's performance and cost over time, thereby identifying any trends that may develop and determining whether the employee is continuing to provide value, or a positive return on investment, over time. The term “employee” is used as a generic term that applies equally to direct hires, contractors, temporary employees, or any other similar relationship between a person performing an assigned task and the person who is responsible for determining whether he or she is performing the task well.

The basic form of the present disclosure as applied to an individual employee is implemented through an assessment module of the type shown in FIG. 1. The assessment module of the program focuses on three Evaluative Aspects common to any employee:
1. The balance of Production Value (“hard skills”) and Intangibles Value (“soft skills”) that an employee must possess to successfully fulfill the requirements of his or her job.
   For example, a machine operator in a manufacturing environment would be expected to master such “hard skills” as how to start a machine, how to verify that it is operating correctly, how to reconfigure it, and how to operate it safely. He or she must also master such “soft skills” as adaptability, attendance, dependability, the ability to work effectively with co-workers, etc.
   The balance between Production Value and Intangibles Value varies depending upon the requirements of a job. Continuing with the example of a machine operator, Production Value (hard skills) is more important than Intangibles Value (soft skills) thus the balance between Production Value and Intangibles Value would be weighted more towards Production Value. On the other hand, the position of Sales Executive would be weighted more towards Intangibles Value than Production Value since the primary skills that are critical for success include strong interpersonal relationships, good people-skills, etc.
2. An employee's performance in each category.
   Using 5 as an average, an employee's performance is rated in each of the two categories, Production Value and Intangibles Value, using a scale of 0 to 10. By combining the relative weighting of Production Value and Intangibles Value with the employee's performance rating in each category, a weighted score is derived using the following formula.

Weighted Score=(Production Value Weight*Production Value Score)+(Intangibles Value Weight*Intangibles Value Score)
3. An employee's relative cost to the company.
   An employee's cost to the company is compared to “average market rate” using a scale of 0-10, with 5 indicating that the employee's cost to the company equals average market rate, 0-4 indicating that the employee's cost is less than average market rate, and 6-10 indicating that the employee's cost is above average market rate.

To be meaningful, an employer must establish a relative standard against which each employee's cost is measured. For most companies, this is accomplished by using industry data to determine the average wage paid in the company's market to a person performing a job. This constitutes the “average market rate” of the position.

The combination of weighted score and relative cost is charted by the software program code as graph 10 to provide a graphical presentation of an employee's Talent Value to his employer, as shown, for example, in FIG. 1. Consider, for example, an employee working as a machine operator. Their supervisor would evaluate their performance using the Talent Value methodology as shown in the following example.

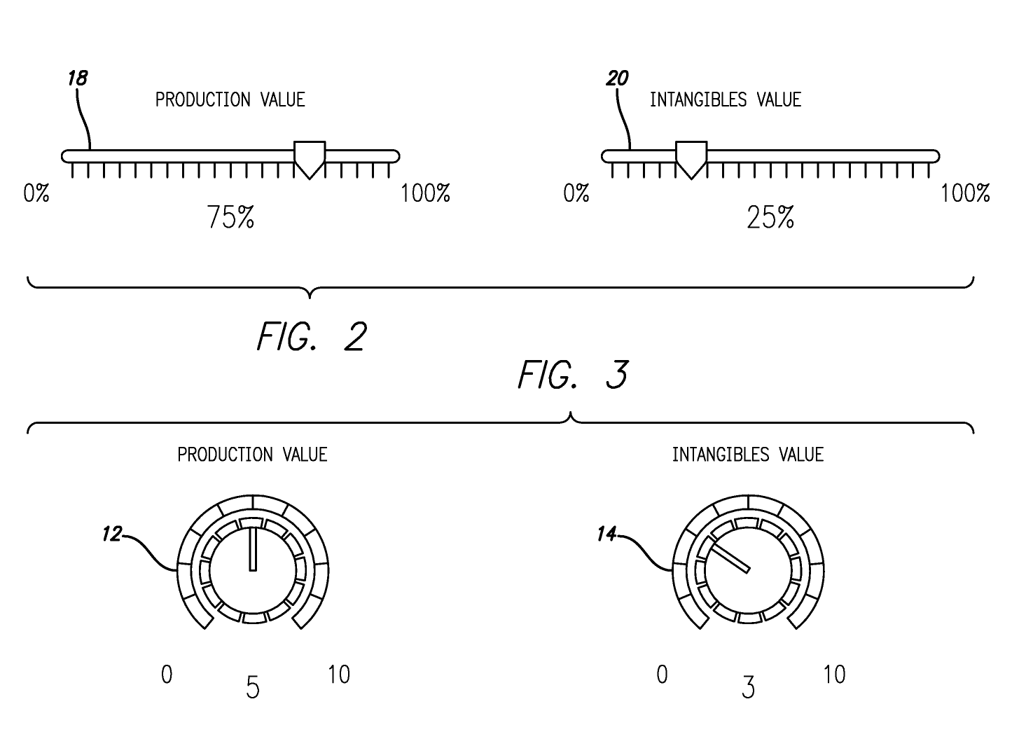

With regard to Production Value versus Intangibles Value set forth in the program a supervisor determines that for a machine operator for example “hard skills” are more important than “soft skills” or, using the Talent Value methodology of the program, the balance between Production Value and Intangibles Value is heavily weighted towards Production Value. In this example, the balance is displayed by setting the Production Value weight slider 18 of the user interface to 75%, resulting in an Intangibles Value weight slider 20 of 25%, as shown, for example, in FIG. 2.

The supervisor then evaluates the performance of the machine operator in terms of Production Value and Intangibles Value by selecting values in the assessment module of the program. In this example, the supervisor rates the employee's performance with regard to Production Value at 5 (average) and Intangibles Value at 3 (below average). The settings for the production value dial 12 and intangibles value dial 14 of the assessment module are graphically represented in FIG. 3.

Using these four values (the Production Value and Intangibles Value weightings for the job and the Production Value and Intangibles Value performance evaluations for the employee) and the formula specified in item 2 under Evaluative Aspects above, the weighted score for the person being evaluated is calculated as follows.

Weighted score=(75%*5)+(25%*3)=3.75+0.75=4.50

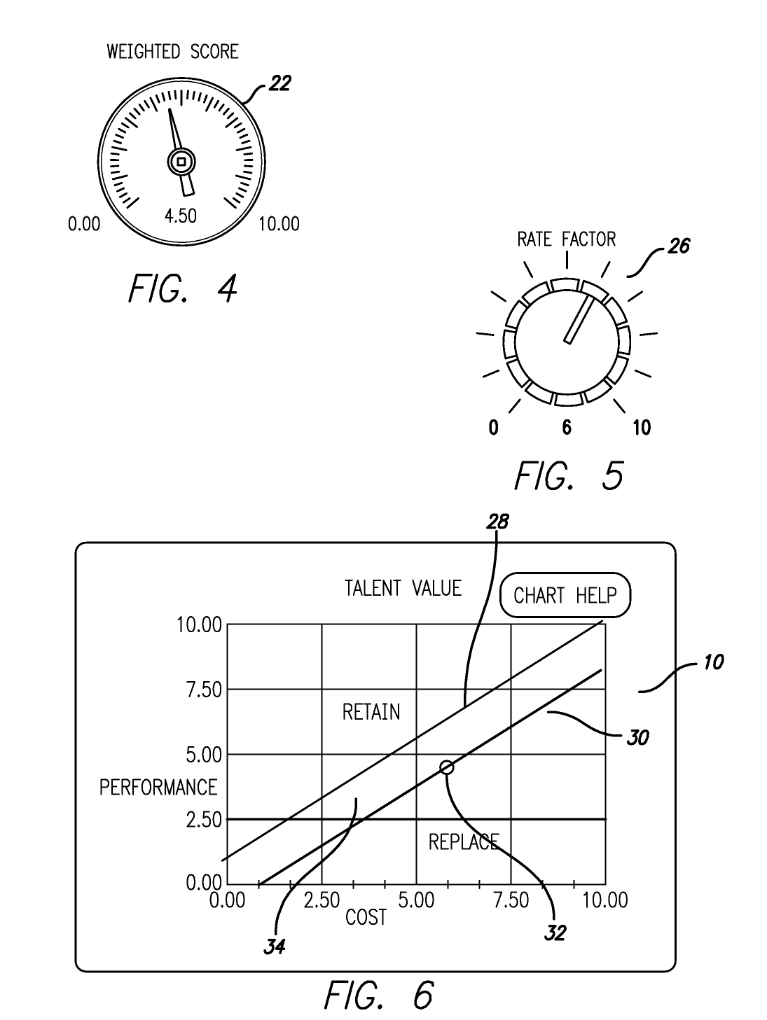

This calculation of the weighted score by the program is graphically illustrated by the user interface through gage 22 as shown in FIG. 4.

Finally, the supervisor assesses the employee's cost as compared to market rate by using dial 26 with 5 indicating “average market rate”. In this example, the employee's cost is rated at 6, indicating that the cost of this employee to his or her employer is slightly above the average market rate for a machine operator performing the same duties. The market rate factor is graphically reflected in FIG. 5. The supervisor selects a market rate value in the assessment module of the program.

Based on the supervisor's evaluation, the Talent Value of the employee being evaluated is displayed graphically by the user interface graph 10 as shown, for example, in FIG. 6. The employee's weighted performance score from steps 1-3 is charted graphically along the y-axis and his or her relative cost from step 4 is charted along the x-axis.

Notice how the graph 10 of FIG. 6 graphically displays the information. The graph shows the upper 28 and lower 30 limit lines relating to the employees performance. As shown, the employees performance 32 falls at the lower end of the talent value spectrum and needs to be retrained or terminated. In this format, not only are the results easy to read, but the graphical display also facilitates comparisons of this employee with others performing similar tasks. Furthermore, it also enables a company to focus on those employees whose Talent Value is above or below that of an average performer. Stated another way, it enables the employer to identify both over achievers and under achievers. This comparison is more evident in the Performance Management Optimization model as discussed in the following section.

The area between the two lines of the graphical display represents the “channel of acceptability” 34 as shown in FIG. 6. Employees who fall below the lower line 32 are under-performing when their actual performance is compared against their cost to their employer. Employers should actively seek ways to replace or retrain them or adjust their cost appropriately. Similarly, employees who fall above the green line are over-performing when their actual performance is compared against their cost. Employers should actively seek ways to retain employees with higher Talent Values through performance recognition, adjustments to their cost, or promotion.

While the Individual Employee assessment module of the program incorporates all of the basic features of the present disclosure, most companies require a more robust performance management tool. The Performance Management Optimization (PMO) assessment module of the present disclosure allows groups of employees to be evaluated and compared to each other within a reporting structure and across the organization. Evaluations using the program can be compared for a single period or across multiple periods of time, thereby providing the ability for company managers to identify trends in employee performance.

The PMO assessment module adds the following features and functionality to the program:

Expanded Definitions of Evaluation Criteria
The Individual Employee assessment module of Talent Value system requires a supervisor to evaluate an employee's overall Production Value and Intangibles Value. The PMO assessment module provides the company with the ability to expand the definitions of Production Value and Intangibles to include a list of specific Quantitative (Production Value) and Qualitative (Intangibles Value) skills applicable to their organization. The expanded definitions allow companies to more accurately define the Quantitative and Qualitative criteria that are deemed critical to success. Furthermore, they allow the supervisor to more clearly identify and document the employee's strengths and weaknesses as a part of the evaluation.

Job-Specific Reviews
The PMO assessment module allows a company to define a list of Quantitative and Qualitative skills that are specific to each job. The result is a set of job-specific evaluation templates, each of which is particular to the specific attributes, skills and responsibilities of a single job.

Criteria and Category Weighting
Each criterion within a category (Qualitative or Quantitative) may not carry the same relative importance to the company. The PMO assessment module allows the company to weigh the criteria that compose each category to provide a more accurate representation of the relative value of each to the job being evaluated. Similarly, as in the Individual Employee assessment module, the relative weight of each category will vary depending upon the job. Therefore, PMO allows the criteria and the categories to be weighted individually, thereby providing the maximum flexibility in describing the relative importance of each facet of a job.

Salary Bands
The PMO assessment module supports the use of salary bands that define the minimum and maximum salaries for each job title by geographic locations. Comparing the employee's actual cost to the company with the salary band that corresponds to the employee's job and geographic location provides a more precise determination of the employee's relative cost.

Tenure-Based Analysis
The ability to chart each employee's Talent Value against their tenure with the company and/or their time in their current job provides another powerful tool for identifying under-achievers and over-achievers.

Trend Analysis
The ability to quickly and accurately review the performance of an employee or groups of employees over time is another component of the PMO assessment module. Trends can be review by employee, job title, work location, or other applicable criteria.

The information that is provided from evaluations recorded in the PMO assessment module may be used as the basis for additional performance management objectives, such as:

Skills Development

Identification of Subject Matter Experts

Identification of Mentors

Rate Evaluations and Merit Increases

Succession Planning

Tenure Analysis and Trends

Supervisor Rating Analysis

Training Program Assessment

360-degree Review

The Evaluative Aspects of the PMO assessment module of present disclosure are the same as those of the Individual Employee assessment module.
1. The balance of Production Value (“hard skills”) and Intangibles Value (“soft skills”) that an employee must possess to successfully fulfill the requirements of his or her job.
   In the PMO assessment module, the balance between Production Value (Qualitative) and Intangibles Value (Quantitative) is still inputted by the supervisor. However, the determination of the relative importance of each of the inputted values is made at a corporate level, thereby eliminating the need for each supervisor to make that determination and ensuring consistency throughout the organization.
2. An employee's performance in each category.
   In the PMO assessment module, a supervisor assesses an employee's value at a more granular level. Rather than inputting single values to each category (Production Value and Intangibles Value), a supervisor inputs a value for each of a pre-defined list of job-specific criteria.
3. An employee's relative cost to the company.
   Because the company, rather than the supervisor, determines employee cost and salary bands, the calculation of an employee's relative cost to the company can occur with no input from the supervisor.

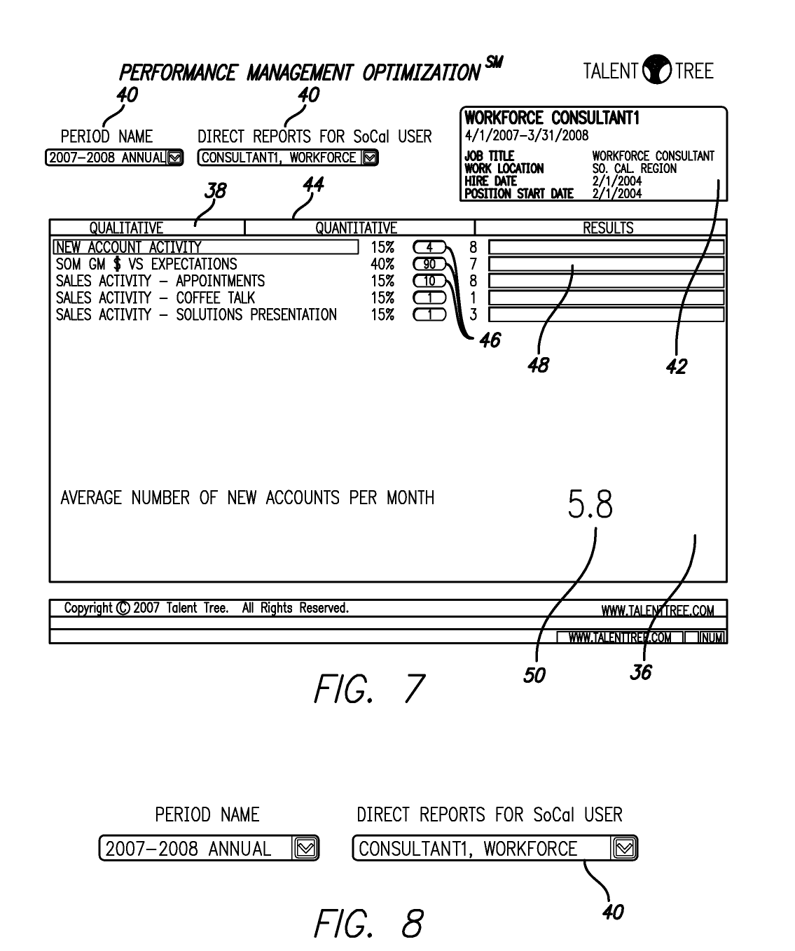

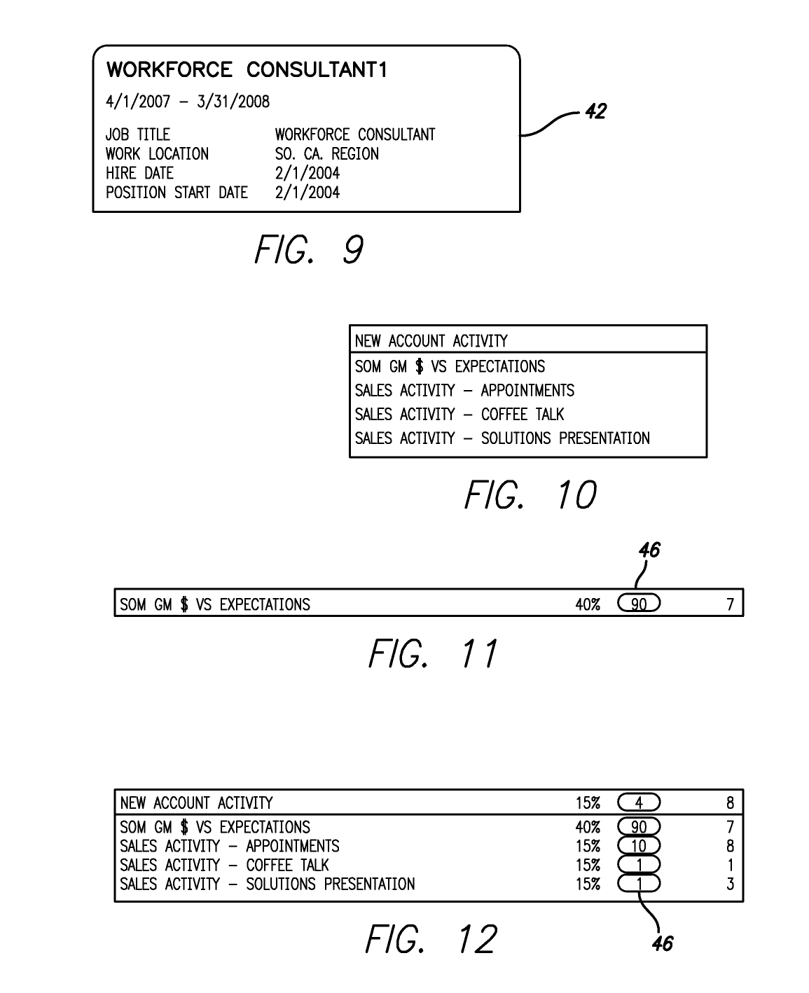

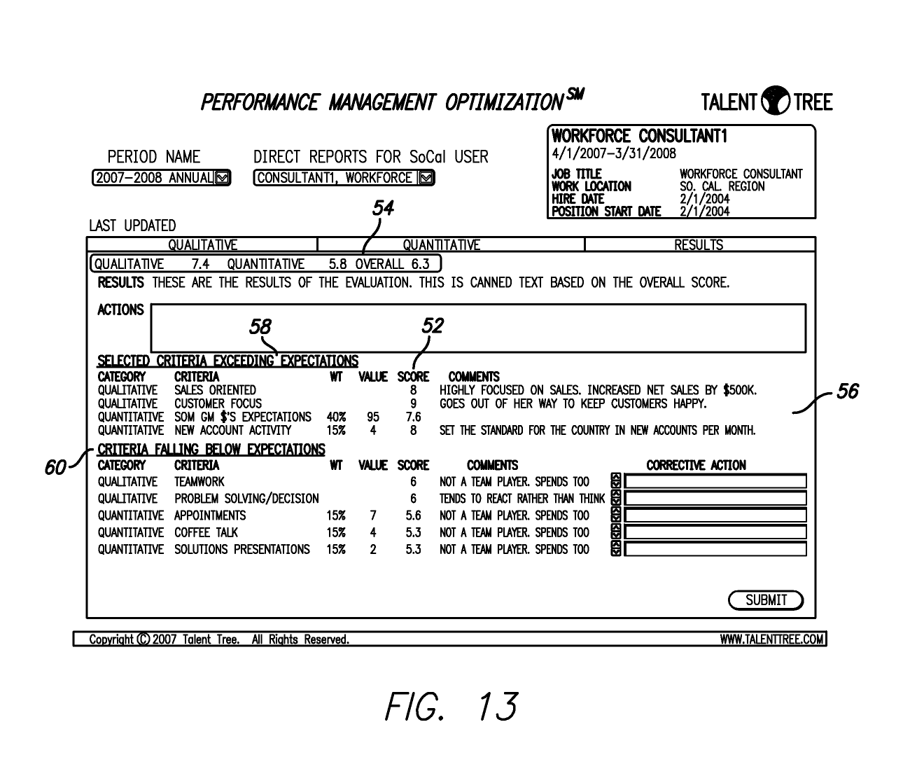

An example of the evaluation portion of Performance Management Optimization assessment module 36 is shown in FIG. 7. FIG. 7 illustrates the Quantitative criteria 38 for an employee's evaluation. The evaluation period and the employee's name are shown in box 40 at the top left of FIG. 7 and shown enlarged in FIG. 8. At the top right of FIG. 7 in box 42 is a summary of the employee's current demographics. The summary is shown in the enlarged view of FIG. 9. The body of the evaluation lists the detailed Quantitative criteria 44 that have been defined for this employee's job title and work location.

By entering the appropriate value in the text box 46 of the graphical display as shown in FIG. 7, the supervisor indicates his or her evaluation of the employee's performance with regard to the specified Quantitative criteria. The text area 48 to the right of each criterion provides space for the evaluator to enter comments pertinent to the employee's performance with regard to that particular criterion, as shown in more detail in FIGS. 9-11. In this particular example, the supervisor has entered a value of 90 for the criterion “SOM GM $ vs Expectations” to indicate that the employee met 90% of his or her gross margin sales expectations. This results in a score of 7 for this criterion. The score for each criterion is derived using the following formula.

Criterion Score=Criterion Rating*Criterion Conversion Factor

The Criterion Conversion Factor used by the program is a multiplier that translates an supervisor's Criterion Rating of an employee into a value that falls within the scoring range defined by the company. For example, a Sales Executive may have as one of his or her Quantitative criteria “% of Annual Sales Target”. The company may decide that a Sales Executive who reaches 100% of his or her annual sales target receives a score of 8. Based on that decision, it can be easily extrapolated that the Criterion Conversion Factor for converting a Criterion Rating of 100 (percent) to a Criterion Score of 8 is 0.08 (100*0.08=8.0). By using 0.08 as the Criterion Conversion Factor for the “% of Sales Target” criteria, a Sales Executive who reaches 80% of his or her annual sales target will receive a Criterion Score of 6.4 (6, rounded) while a Sales Executive who reaches 120% of his or her annual sales target will receive a Criterion Score of 9.6 (10, rounded).

The number at the bottom of FIG. 7 at 50 (i.e. 5.8) is the employee's overall Quantitative category score. This value is derived using the following formula.

Category Score=Σ(Criterion Score*Criterion Weight)

In this example, the supervisor has rated the employee as shown in FIG. 11, which is part of FIG. 7. The Category Score is calculated using the formula defined above.

Category Score=(8*15%)+(7*40%)+(8*15%)+(1*15%)+(3*15%)=5.8

The Qualitative and Quantitative scores are combined based on the weighting assigned by the company. For example, if the company decided that Quantitative scores should comprise 70% of an employee's overall score, an employee who received a 7.4 Qualitative score and a 5.8 Quantitative score would receive an Overall score of 6.3 as shown below.

Overall Score=(7.4*30%)+(5.8*70%)=6.3

After the supervisor has completed her or her assessment of an employee using the appropriate Qualitative and Quantitative criteria, he or she is presented with a summary 56 of the employee's evaluation as represented in FIG. 13. The key elements represented in FIG. 13 are:
1. The employee's score 52 in each category (Qualitative and Quantitative) along with their overall evaluation score 54.
   The employee's overall score is calculated using the following formula. This is the same calculation that is used to calculate the employee's weighted score in the Individual Employee assessment module of Talent Value system. In the Individual Employee assessment module, the supervisor is responsible for determining the weight to be assigned to each category. In the Extended Application (PMO) the determination is made by company management as a part of the initial setup and configuration of PMO. This ensures a consistent application of weights across all employees and jobs.

Overall Score=(Qualitative Weight*Qualitative Score)+(Quantitative Weight*Quantitative Score)
2. A recap 58 of the criteria for which the employee received their highest scores.
3. A listing 60 of all criteria for which the employee's score falls below the pre-established Target Score.
   As a part of the initial setup and configuration, the company defines a Target Score. The Target Score represents the minimum level of acceptable performance for each criterion. For each criterion for which the employee's score falls below the Target Score, the supervisor is provided the opportunity to identify the corrective actions to be taken to improve the employee's performance for the next evaluation period.

When the supervisor presses the Submit button, the employee's evaluation is written to the database and stored on a mass storage device. Each evaluation is stamped with the date and time the evaluation was saved to the database and the name of the supervisor who completed the evaluation.

A second component of the Performance Management Optimization (PMO) assessment module is supervisor-level reporting. This component allows each supervisor to review the results of all evaluations across the company at a summary level and the results of his/her employees at a detailed level.

FIG. 14 provides a summary box 62 of the results of all evaluations across the organization for the period Apr. 1-Oct. 31, 2007. From these charts, it is easily seen that 95% of the reviews have been completed to-date and that the Average Overall Score for those reviews was 7.56. Furthermore, the lower pie chart 64 makes it clear that 79% of the employees who were evaluated had an Overall Score that was above the Expected Score of 7.

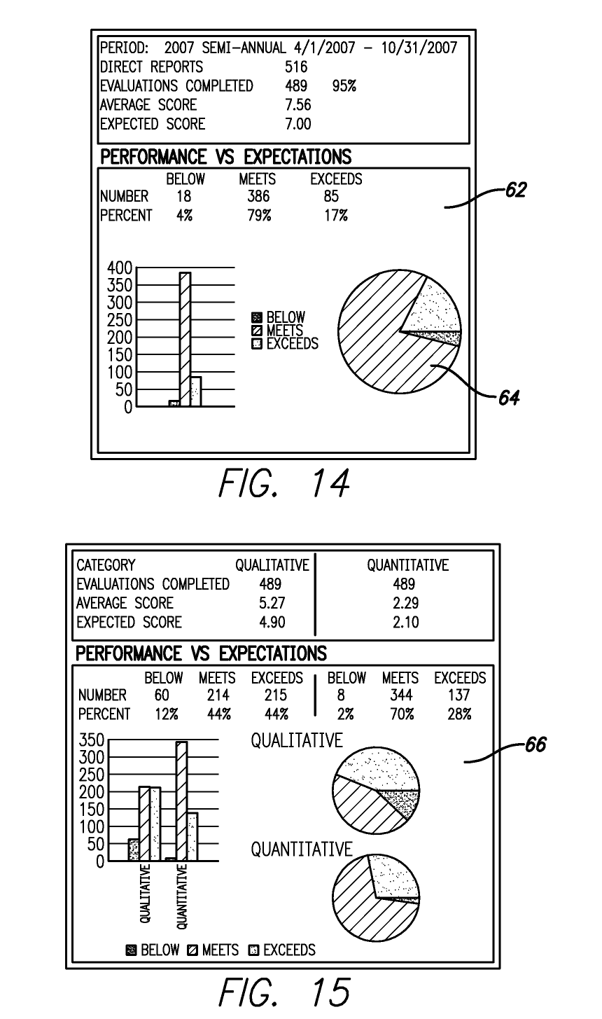

FIG. 15 shows a summary box 66 including the same data broken out by category. From this chart, it is apparent that 88% of the employees had Qualitative scores that met or exceeded expectations and that 98% of the employees had Quantitative scores that met or exceeded expectations.

FIG. 16 shows an xy-chart 16 (scatter gram) of all employees 68 who were evaluated for the specified period. The bold horizontal and vertical lines reflect the Target Score for each category as defined by the company. Employees whose scores fall in the upper right quadrant exceed the Target Score in both categories. Those with scores falling in the lower left quadrant fall below the Target Score in both categories. Similarly, those with scores in the upper left and lower right quadrants fall above the Target Score in one category and below the Target Score in the other.

In addition to summary-level charts across the organization, charts are available that provide a cross-sectional view of a supervisor's employees in a number of areas as illustrated in the figures below. FIG. 17 is an xy-chart (scatter gram) of the Qualitative and Quantitative scores for all employees who report to a given supervisor. The bold horizontal and vertical lines reflect the Target Score for each category as defined by the company. Employees who fall in the upper right quadrant exceed the Target Score in both categories. Those employees whose scores fall in the lower left quadrant fall below the Target Score in both categories. Similarly, those employees whose scores are in the upper left or lower right quadrants fall above the Target Score in one category and below the Target Score in the other.

The chart of FIG. 17 is particularly useful to the user for several reasons. First, it provides a dramatic visualization of the Quantitative and Qualitative score for all of the employees who report to a particular supervisor. In this particular example, the following observations are readily apparent: a) Most of the employees were evaluated as exceeding the Target Score in the Qualitative and Quantitative categories; b) A significant number of employees were evaluated as failing to meet the Target Score in either the Qualitative or Quantitative category; c) Very few employees were evaluated as failing to meet the Target Score in only one category.

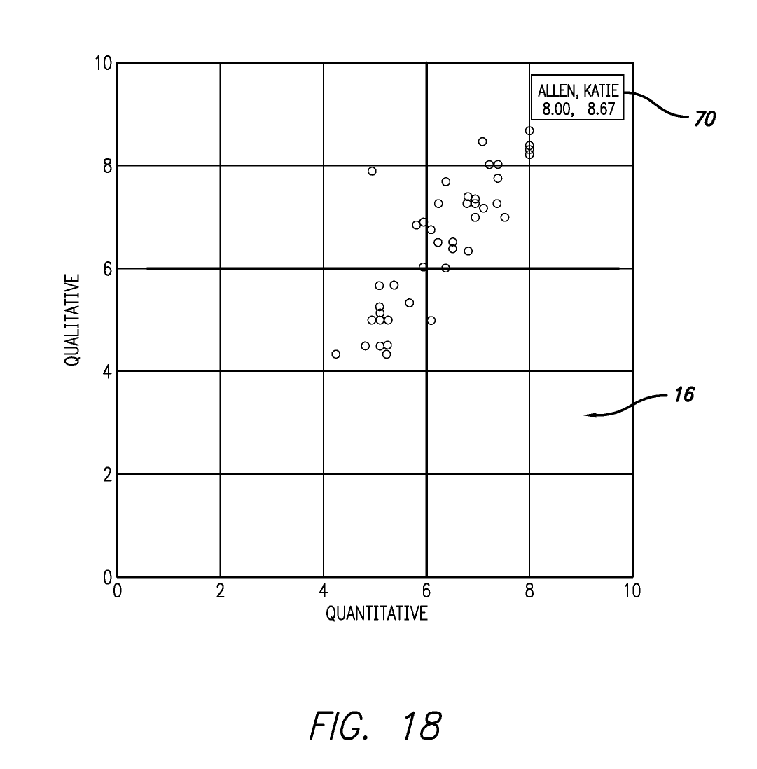

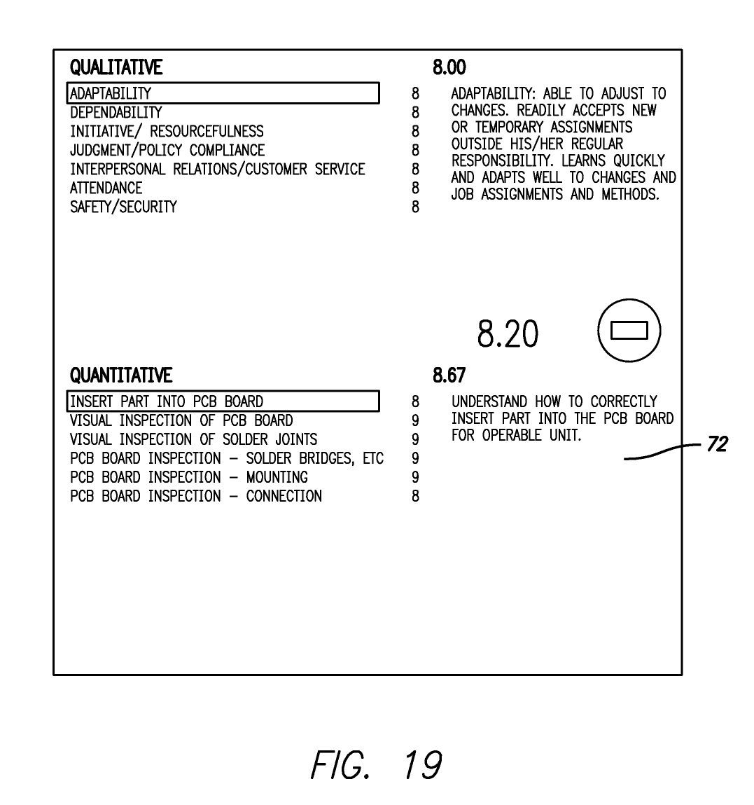

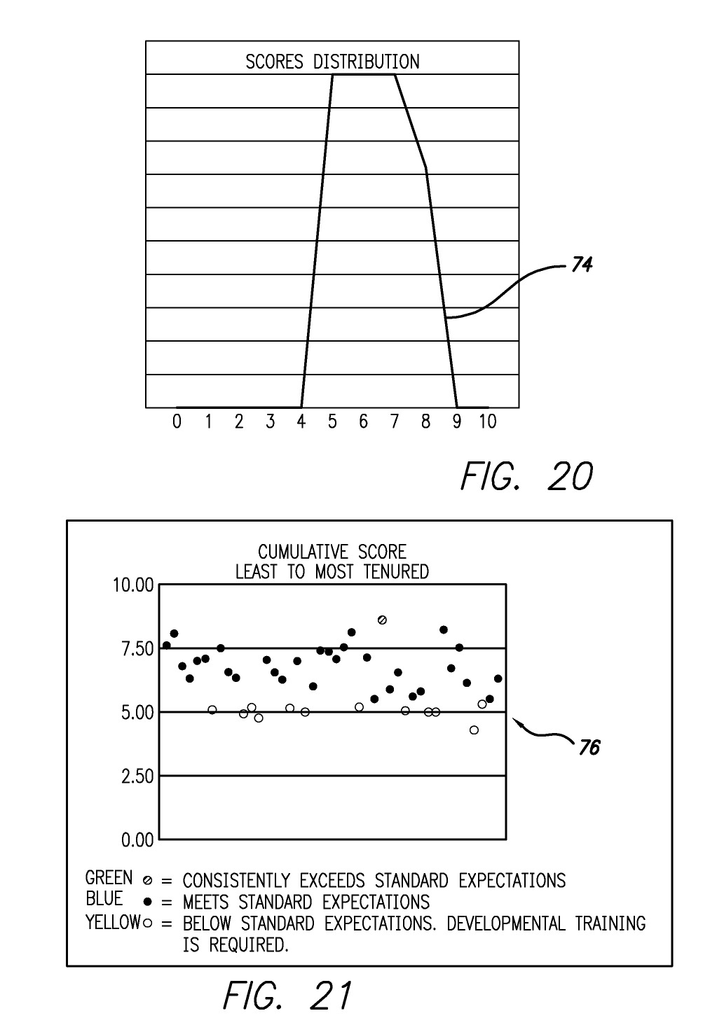

The technology behind the tool provides a supervisor with the ability to hover his or her mouse over each point on the chart and identify the employee to which each point corresponds and the employee's score in each category, as shown in box 70, for example, in FIG. 18. By clicking on any point, a supervisor is able to view the detailed evaluation box 72 for the employee selected in the previous step, as shown in FIG. 19. FIG. 20 is a distribution curve 74 of all cumulative scores. From this chart, it is apparent that all employees had a cumulative score between 4 and 9, with the majority of employees falling between 5 and 7.

FIG. 21 includes a graph 76 charts cumulative scores with regard to the employee's tenure within the organization. Least-tenured employees are to the left of the chart and most-tenured employees are to the right. Each employee's score is color-coded with regard to expected score ranges. Another version of this chart shows cumulative scores with regard to the employee's time in his or her current position. As with the scatter gram in FIG. 4, a supervisor can hover his or her mouse over the chart to identify the name of the employee to which each point corresponds and the employee's cumulative score. By clicking on the selected point, a supervisor can view an employee's evaluation as shown in FIG. 19.

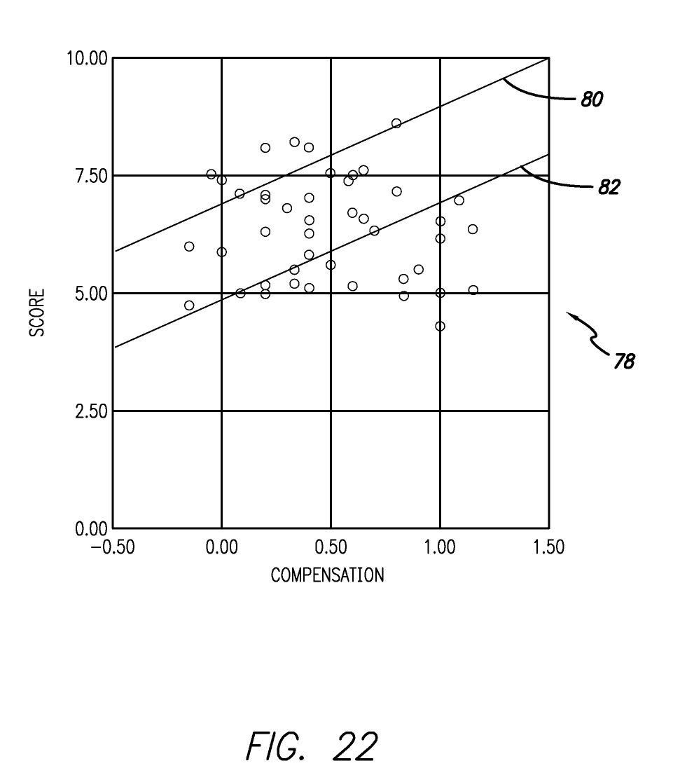

FIG. 22 includes chart 78 adds employee compensation to the chart for a true Talent Value look at the organization. In this chart, each employee's cumulative score is charted along the y-axis. The x-value represents where an employee's compensation falls as a percentile within the pre-defined salary band. The salary band is identified by the dark vertical lines at 0.00, 0.50, and 1.00. These lines represent the bottom (0%), midpoint (50%), and top (100%) of the salary band. As in the Single Employee Application, the area between the upper 80 and lower 82 lines represents the Target Area (“channel of acceptability”). Employees with a Talent Value that falls above the upper line 80 are over-performing based on their job requirements and cost. Those with a Talent Value that falls below the lower line 82 are under-performing based on the same criteria.

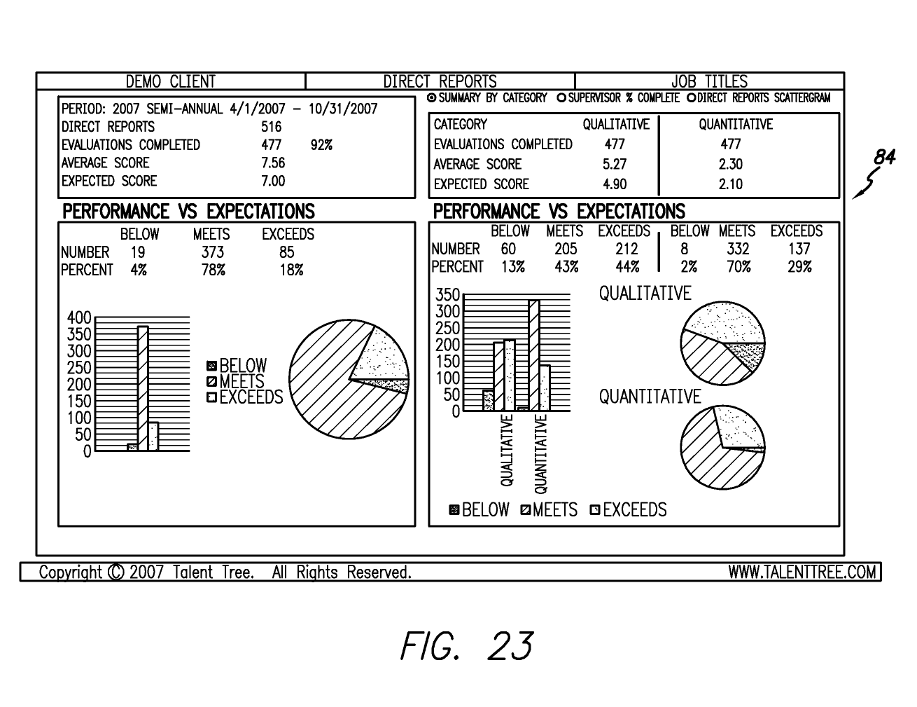

In addition to being able to view all employees as a group, reports and charts similar to the ones shown above are available which allow the supervisor to view employees based on job-title, location, and other distinguishing criteria as defined by the organization. The Management Reporting component of the Performance Management Optimization assessment module provides the ability for senior management to view evaluation results holistically across the company or at a more granular level by use of chart 84, as shown in FIG. 23.

Chart 84 of FIG. 23 is the same organizational-level overview of the evaluation results that is available to the supervisors. From chart 84, senior-level management is able to drill down into the detailed results and see information, such as a breakout by region, area, or other grouping of all employees who fell below expectations, either overall or within a particular category. The ranges defined as “below”, “meets” and “exceeds expectations” can be pre entered for the sake of analysis and benchmark reporting. These data points can also be dynamically changed to allow “what if” analysis at any level.

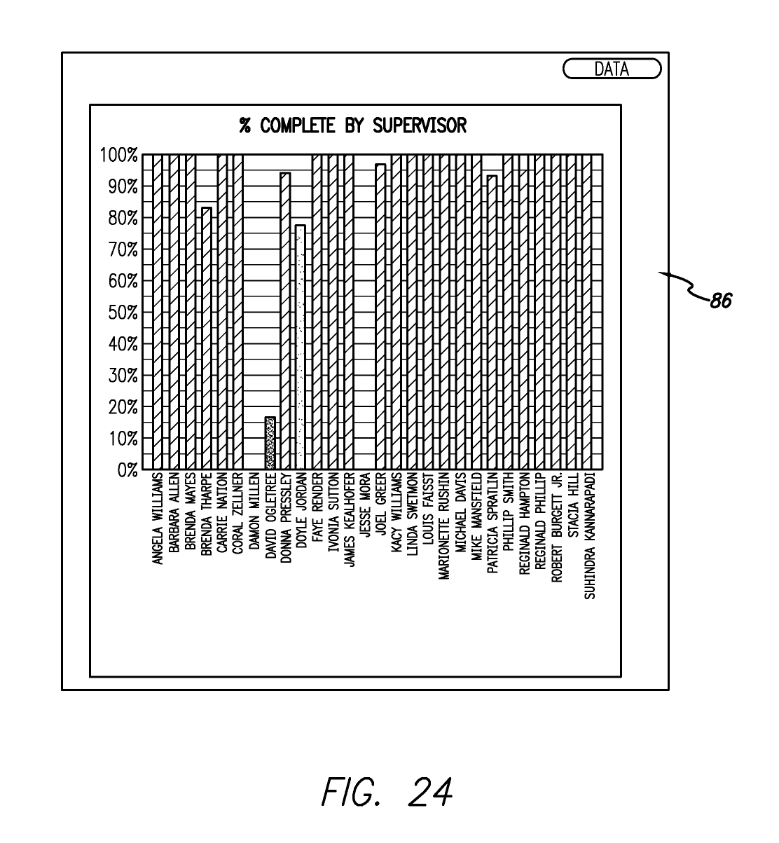

FIG. 24 is a graphical display 86 that identifies all supervisors and the percentage of their evaluations that have been completed for the period. A data-only version of this information is also available. The Management Reporting component also provides the ability to view the same data and reports available in the Supervisor Reporting component by simply selecting a supervisor's name from a list. Additional reporting provides the ability to view scores by region, geographic area, work location, job title, etc.

The Performance Management Optimization assessment module has the ability to identify trends. Trend reporting refers to the ability to chart an employee or organization's performance over time. All of the charts and reports identified above are available to review a single period or selected trends. From within a trend report, the user can drill down to the specific period reporting shown previously.

Utilizing the Talent Value performance appraisal system an evaluator can determine the cost to the company of an employee or other person as a key element in an overall performance review. The cost of the person, used in combination with traditional objective and subjective measures of performance, enables an evaluator to measure the company's return on investment in the person. This enables the evaluator to determine which persons should be retained and those who should be terminated.

The system performance appraisal system enables an appraiser to compare the return on investment of all employees in one job category or throughout a company.

The software enables the evaluator to select and specify each of the critical qualitative and quantitative elements of each of its positions so it can more accurately evaluate whether a person is successfully performing given tasks. This forces the evaluator to think very carefully about what factors in every job are most critical to success, thereby allowing the evaluator to focus attention on what will make the company successful at every level.

As stated, the system enables the evaluator to determine for each position the relative importance of quantitative versus qualitative factors or traits. For example, an evaluator may determine that qualitative traits, such as social skills, are more important to a sales person than quantitative skills, whereas the converse might be true with respect to a punch press operator. They can also weight individual criteria within a category. For example, some qualitative skills may be more important than others.

Utilizing the system, the evaluator can compare the cost and overall performance of each member of a team of workers and the evaluator can also compare the relative cost and overall performance of one team as compared to another team. Thus, a company with a limited budget may conclude that, based upon the cost/performance data it would be more economical if the company were to outsource a particular function.

The system utilizes dashboard display graphics that are easy to understand for the user. The use of dashboard graphics with virtual dials provides a sophisticated and user-friendly means by which evaluators can perform the evaluation and cost analysis. The dashboard graphical format also enables evaluators to compare at a glance the performance and cost of individuals within a group or to compare the performance and cost of one group with another group.

The results of the application of the appraisal system are displayed in a visual manner that allows the evaluator to understand fully the overall performance evaluation and the cost to the company of each person and group evaluated. Further, it enables the evaluator to take specific remedial action in many areas, such as, by way of example: Skills development; Identification of subject manner experts; Identification of individuals to be put on performance improvement plans; Evaluation of individual performance trends; Evaluation of groups of employees by tenure or other criterion; Evaluation of supervisor hiring decisions; Evaluation of supervisor performance management; and the creation of objective performance standards that identify the range of meeting expectations, below expectations and exceeding expectations.

The methodology of the appraisal system enables evaluators to monitor performance and cost of individuals and groups of individuals over time and to compare the results of those evaluations, thereby assessing whether an individual's performance has improved, declined, or remained steady.

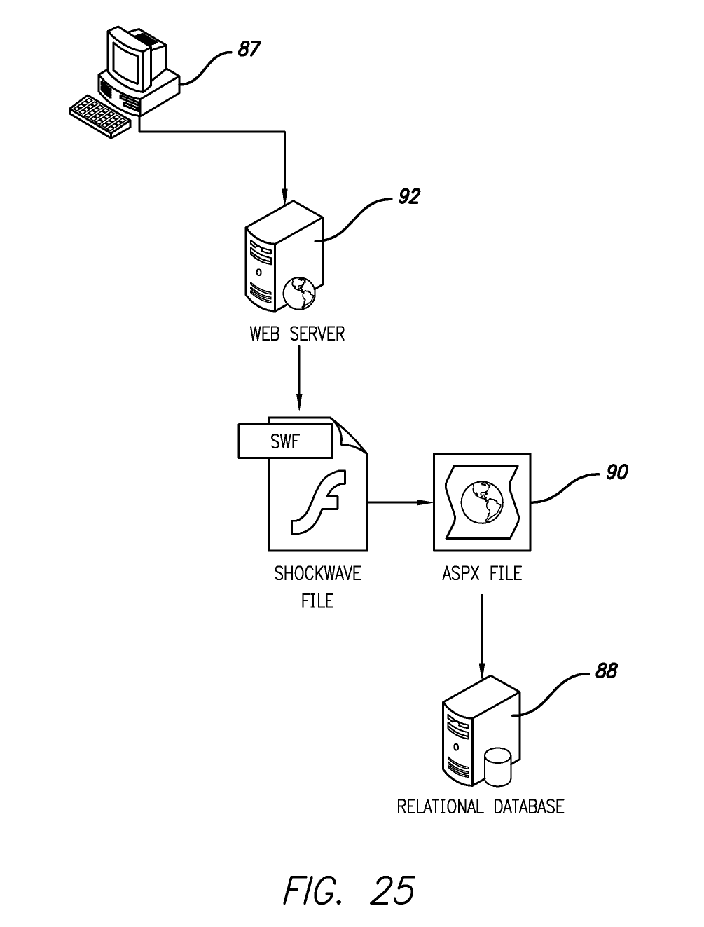

The data that comprises an evaluation and viewed from terminal is stored in a secure relational database 88 (Oracle, SQL Server, etc.) residing on a network, as shown, for example, in FIG. 25. The mechanism for accessing, creating, and updating the evaluation is a Shockwave® file generated using Crystal Xcelsius®. The file is deployed across the Internet and accessed through a standard web server 92 and web browser through a terminal such as terminal 87. Interaction between the Shockwave file and the database is accomplished via XML generated by an ASPX script 90.

The computer software is used to evaluate the performance of one or more employees and includes a mass storage device, a processor device and a user interface module that is connected to the mass storage device and the processor device. The user interface module is configured to display a predetermined range of production values and allows a user to select a production value to rate the performance of an employee in relation to the employee's position. The user interface module is also configured to display a predetermined range of intangible values and the program allows the supervisor to select a value from the range of intangible values to rate the performance of the employee in relation to the employee's position.

The user interface module is also configured to display a predetermined range of weighted values and allows the supervisor to select from the range of weighted values. The system assigns the weighted values to the production and intangible values to generate weighted production and intangible values used to evaluate the employee. The processor device of the system calculates a weighted employee score based upon the employee's weighted production and intangible values as described above and graphs the weighted employee score against the market value of the employee. The market value of the employee is what the employee is being paid in relation to market price for their position as described above. The user interface module graphically illustrates the value of the employee based upon job performances so that the supervisor can assess the value of the employee.

The user interface module is also configured to graphically illustrate performance target scores so that the supervisor can determine whether the employee meets performance targets. The weighted employee scores of multiple employees can also be graphically displayed on the user interface module so that the overall performance of a group of employees can be evaluated by the user. The supervisor can also select an individual weighted employee score from the graphical display to identify an individual employee on the graphical display. After a supervisor selects the production and intangible values and assigns selected weighted value the supervisor can save the data entered by the employer on the mass storage device along with the date, time, and the name of the supervisor.

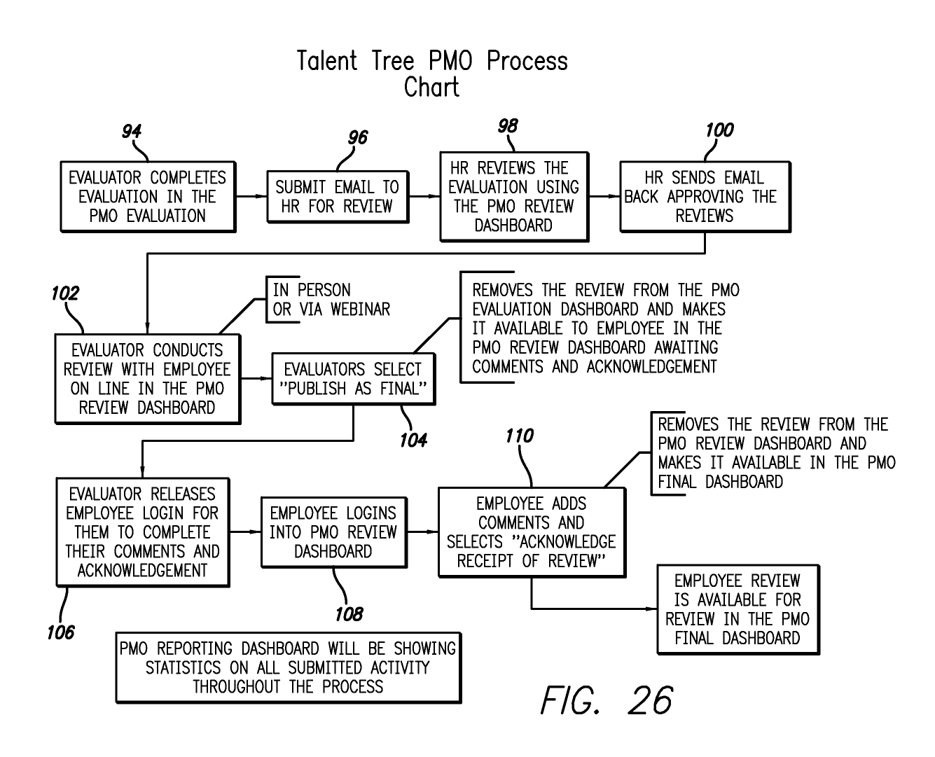

Performance Management Optimization process used by the program in evaluating an employee or a series of employees 94 is shown in FIG. 26. In evaluating the performance of an employee, an evaluator evaluates an employee and submits the evaluation to human resources 96 for review. Human resources reviews the evaluation using the performance management optimization review dashboard interface 98 and then sends an email back to the evaluator approving the review 100. The evaluator then conducts a review with the employee on line in the PMO assessment module dashboard interface 102. After the review, the evaluator publishes the review as final 104, which removes the review from the PMO assessment module evaluation dashboard, which makes the review available to the employee in the PMO assessment module review dashboard 106 awaiting comments and acknowledgement. By using a login, an employee can review their final evaluation in the PMO assessment module 108 review dashboard and can added comments and acknowledge receipt of review 110. Finalizing the review removes the review from the PMO assessment module review dashboard and makes it available in the PMO assessment module final dashboard.

The system of the present disclosure includes software that is intended to run on a variety of computing platforms and devices as well as mobile devices. One or more software modules operative to, when loaded on a computing device, provide the functionality described above may also be loaded onto a computer readable media, such as a CD-ROM, floppy disc, DVD, other storage media, or other computer program product. The software modules may also be made available as a file download or operate as a plug-in to a browser, or be delivered as a web-based or ASP application. The software module may also be written or delivered via a Flash product from Adobe, Inc or Silverlight from Microsoft Corp. The term “computer module” or “software module” referenced in this disclosure is meant to be broadly interpreted and cover various types of software code including but not limited to routines, functions, objects, libraries, classes, members, packages, procedures, methods, or lines of code together performing similar functionality to these types of coding. The components of the present disclosure are described herein in terms of functional block components, flow charts and various processing steps. As such, it should be appreciated that such functional blocks may be realized by any number of hardware and/or software components configured to perform the specified functions. For example, the present disclosure may employ various integrated circuit components, e.g., memory elements, processing elements, logic elements, look-up tables, and the like, which may carry out a variety of functions under the control of one or more microprocessors or other control devices. Similarly, the software elements of the present disclosure may be implemented with any programming or scripting language such as Cold Fusion, C, SQL, C++, Java, Javascript, COBOL, assembler, CSS, Ajax, Fusebox, PERL, or the like, with the various algorithms being implemented with any combination of data structures, objects, processes, routines or other programming elements. Further, it should be noted that the present disclosure may employ any number of conventional techniques for data transmission, signaling, data processing, network control, and the like as well as those yet to be conceived.

While embodiments have been illustrated and described in the drawings and foregoing description, such illustrations and descriptions are considered to be exemplary and not restrictive in character, it being understood that only illustrative embodiments have been shown and described and that all changes and modifications that come within the spirit of the invention are desired to be protected. The applicants have provided description and figures which are intended as illustrations of embodiments of the disclosure, and are not intended to be construed as containing or implying limitation of the disclosure to those embodiments. There are a number of advantages of the present disclosure arising from various features set forth in the description. It will be noted that alternative embodiments of the disclosure may not include all of the features described yet still benefit from at least some of the advantages of such features. Those of ordinary skill in the art may readily devise their own implementations of the disclosure and associated methods, without undue experimentation.

1. A system for evaluating the performance of one or more employees, the system comprising:
a mass storage device;
a processor device;
a user interface module connected to the mass storage device and the processor device, the user interface module configured to display a predetermined range of production values and allows a user to select a production value to rate the performance of an employee in relation to the employee's position;
the user interface module also configured to display a predetermined range of intangible values and allows the user to select a value from the range of intangible values to rate the performance of the employee in relation to the employee's position;
the user interface module also configured to display a predetermined range of weighted values and allows the user to select from the range of weighted values and assign the weighted values to the production and intangible values to generate weighted production and intangible values; and
the processor device configured to calculate a weighted employee score based upon the employee's weighted production and intangible values and graph the weighted employee score against the market value of the employee, the user interface module configured to graphically illustrate the value of the employee based upon job performances so that the user can assess the value of the employee,
wherein the production values and intangible values are interrelated so that an adjustment of one of the production values or intangible values results in an automatic adjustment of the other of the production values or intangible values.

2. The system of claim 1, wherein range of weighted values are preset for a given employee position.

3. The system of claim 1, wherein the user interface module is also configured to graphically illustrate performance target scores so that the user can determine whether the employee meets performance targets.

4. The system of claim 1, wherein the weighted employee scores of multiple employees are graphically displayed on the user interface module so that the overall performance of a group can be evaluated by the user.

5. The system of claim 4, wherein the user can select an individual weighted employee score from the graphical display to identify an individual employee on the graphical display.

6. The system of claim 1, wherein the user, after selecting the production and intangible values and assigning selected weighted values can save the data entered by the user on the mass storage device along with the date, time, and the name of the user.

7. A computer readable medium having program code stored thereon for manipulating digital data, when executed on a computer, causing the computer to perform a method, the method comprising:
providing a user interface displaying a predetermined range of values to allow a user to select a value from the range of values to rate the performance of an employee in relation to a production value associated with the employee's job;
displaying a predetermined range of values to allow a user to select a value from the range of values to rate the performance of the employee in relation to an intangible value associated with the employee's job;
displaying a predetermined range of weighted values that can be selected by the user and assigned to the production value and the intangible value selected by the user to generate weighted production and intangible values, the production and intangible values being interconnected so that an adjustment in the weighting of one results in an automatic adjustment of the other;
calculating a weighted employee score based upon the employee's weighted production and intangible values;
selecting an average market value from a database of average market values for employees with similar jobs; and
displaying a graphical display that graphs a rate of the employee to the weighted employee score to graphically illustrate the value of the employee based upon job performance.

8. The computer readable medium of claim 7, wherein range of weighted values are preset for a given employee position.

9. The computer readable medium of claim 7, comprising program code causing the computer to graphically display performance target scores so that the user can determine whether the employee has meet performance targets.

10. The computer readable medium of claim 7, comprising program code causing the weighted employee scores of multiple employees to be graphically displayed so that the user can the overall performance of a group can be reviewed.

11. The computer readable medium of claim 10, wherein the user can select an individual weighted employee scores from the graphical display to identify an individual employee.

12. The computer readable medium of claim 7, comprising program code that, after the user selects the production and intangible values and assigns selected weighted values, saves data entered by the user along with the date, time, and the name of the user.

13. A method for evaluating the performance of one or more employees working for a business, the method comprising the steps of:
inputting one of a predetermined range of values to rate the performance of an employee in relation to the production value associated with the employee's job at the business;
inputting one of a predetermined range of values to rate the performance of the employee in relation to the intangible value associated with the employee's job at the business;
weighing the production and intangible values of the employee based upon the employee's job requirements;
calculating a weighted employee score based upon the employee's weighted production and intangible values;
comparing the weighted employee score against an average market rate of employees to determine the value of the employee; and
graphing the average market rate of the employee to the weighted score to graphically illustrate the value of the employee based upon job performance.

14. The method of claim 13, wherein range of weighted values are preset for a given employee position.

15. The method of claim 13, comprising the step of causing the computer to graphically display performance target scores so that the user can determine whether the employee has meet performance targets.

16. The method of claim 13, comprising the step of causing the weighted employee scores of multiple employees to be graphically displayed so that the user can the overall performance of a group can be reviewed.

17. The method of claim 16, wherein the user can select an individual weighted employee score from the graphical display to identify an individual employee.

18. The method of claim 13, comprising the step of saving data entered by the user along with the date, time, and the name of the user.

19. The method of claim 13, comprising the step of graphing an employee's performance over time to permit the identification of trends in the employee's performance.
